(19) United States
(12) Patent Application Publication
(10) Pub. No.: US 2004/0218636 A1
(43) Pub. Date: Nov. 4, 2004

(54) Laser apparatus, laser system, and laser apparatus manufacturing method

(75) Inventors: Noriyasu Kashima, Yokhama-shi (JP); Akira Ushijima, Yokohama-shi (JP); Kazuhito Higuchi, Yokohama-shi (JP); Takashi Togasaki, Yokohama-shi (JP); Tooru Sugiyama, Kumagaya-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/792,276

(22) Filed: Mar. 4, 2004

(30) Foreign Application Priority Data
Mar. 5, 2003 (JP) 2003-058750

(51) Int. Cl. H01S 3/10

(52) U.S. Cl. 372/9; 372/43

(57) ABSTRACT

A laser apparatus comprises a semiconductor laser element which emits a light beam with a spread in a slow-axis direction and a fast-axis direction, a fast-axis collimating lens which controls the spread in the fast-axis direction of the light beam emitted from the semiconductor laser element, a reflector which returns the light beam emitted in the slow-axis direction in a specific angle range to the semiconductor laser element, a reflector supporting member which supports the reflector, and a side support member which supports the fast-axis collimating lens and the reflector supporting member in the slow-axis direction with respect to the semiconductor laser element.

### CROSS-REFERENCE TO RELATED APPLICATIONS

This application is based upon and claims the benefit of priority from prior Japanese Patent Application No. 2003-058750, filed Mar. 5, 2003, the entire contents of which are incorporated herein by reference.

### BACKGROUND OF THE INVENTION

1. Field of the Invention

This invention relates to an external-resonator laser apparatus, a laser system including the laser apparatus, and a method of manufacturing the laser apparatus.

2. Description of the Related Art

An outline of an external-resonator semiconductor laser has been written in “OPTICS LETTERS,” Vol. 27, No. 3, Feb. 1, 2002, pp. 167-169. This type of semiconductor laser emits a light beam excited in a semiconductor chip outside the chip. The light beam is then caused by a reflector to return to the inside of the chip again for resonance, thereby generating a high output light beam. Since the size of the light-emitting region is as small as 2 to 10 microns, the semiconductor chip, lens section, and reflector have to be positioned with very high accuracy in this type of semiconductor laser. The accuracy of the position of the fast-axis collimating lens that makes the emitted light beam parallel with the fast-axis direction of the semiconductor chip especially has to be maintained in the order of submicrons with respect to the semiconductor chip. The accuracy of the position of the reflector that causes the light beam to return to the inside of the semiconductor chip has to be maintained in the order of 0.01° or less in tilt angle with respect to the semiconductor chip.

In many cases, a semiconductor chip is joined to a metallic mount member with solder. At that time, there arise a variation in the junction position (usually, about 10 microns) and a variation in the thickness of solder (usually, several microns). To obtain the desired performance even when such variations occur, the position of the fast-axis collimating lens and that of the reflector have to be adjusted in the three axis directions with respect to the semiconductor chip.

Techniques related to the positioning control of a semiconductor laser system have been disclosed in Jpn. Pat. Appln. KOKAI Publication No. 11-52177 ([0030] to [0034], FIG. 1). The laser system in the publication has two coupling lenses in a coupling structure including a semiconductor laser element (or laser diode) and optical fiber. The position of each of the lenses is designed to be adjusted between the semiconductor laser element and the optical fiber. The distance between the lenses is also designed to be adjusted. By doing this, the adjustment sensitivity at the adjusting place is made lower, thereby realizing the position adjustment with high accuracy and high reliability, and facilitating the manufacture. The laser diode described in the publication is not of the external resonator type but of the edge light-emitting type.

As described above, to cause the external resonator semiconductor laser to achieve the desired performance, it is necessary to position the component parts, including the semiconductor chip, lens section, and resonator, with very high accuracy. In addition, to mass-produce external-resonator semiconductor lasers commercially, it is required to perform positioning control with higher accuracy, simplify the positioning control, carry out the positioning control at lower cost, and maintain the positioning control accuracy over a long period.

### BRIEF SUMMARY OF THE INVENTION

It is, accordingly, an object of the present invention to provide a low-cost laser apparatus capable of being assembled with high accuracy in a short time, maintaining the accuracy over a long period, and a laser system, and a method of manufacturing the laser apparatus.

According to an aspect of the present invention, there is provided a laser apparatus comprising a semiconductor laser element which emits a light beam with a spread in a slow-axis direction and a fast-axis direction; a fast-axis collimating lens which controls the spread in the fast-axis direction of the light beam emitted from the semiconductor laser element; a reflector which returns the light beam emitted in the slow-axis direction in a specific angle range to the semiconductor laser element; a reflector supporting member which supports the reflector; and a side support member which supports the fast-axis collimating lens and the reflector supporting member in the slow-axis direction with respect to the semiconductor laser element.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 is a schematic diagram of an external-resonator laser apparatus according to an embodiment of the present invention;

FIG. 2 is a schematic diagram showing the way the external-resonator laser apparatus of FIG. 1 is mounted on the mount member 4;

FIG. 3 is a perspective view of the external-resonator laser apparatus of an embodiment of the present invention;

FIG. 4 shows the laser apparatus of FIG. 3 viewed in the direction shown by the arrow A;

FIG. 5 is a sectional view of the laser apparatus of FIG. 3 taken in the direction shown by the arrow B;

FIG. 6 is a sectional view showing the configuration of a laser system using the laser apparatus in FIGS. 3 to 5; and

FIG. 7 is a flowchart showing a method of manufacturing the laser apparatus of FIG. 3 and the laser system of FIG. 6.

### DETAILED DESCRIPTION OF THE INVENTION

Hereinafter, referring to the accompanying drawings, an embodiment of the present invention will be explained.

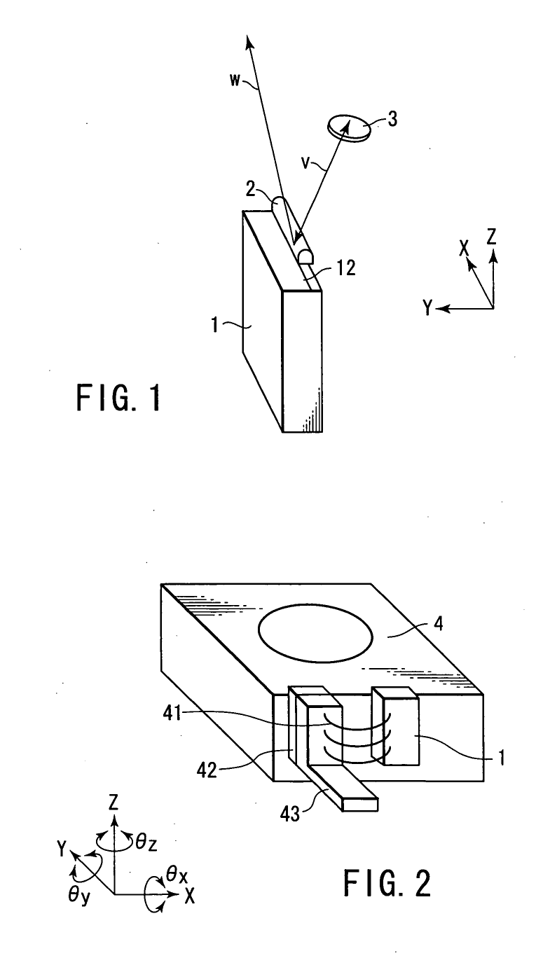

FIG. 1 is a schematic diagram of an external-resonator laser apparatus according to an embodiment of the present invention. In FIG. 1, reference numeral 1 indicates a single-stripe multimode oscillation semiconductor laser. In this type of semiconductor laser, the light-emitting region (not shown) exposed at a light emitting end 12 is composed of a single active layer. In the explanation below, the direction perpendicular to the light-emitting end 12 is defined as the Z axis, the slow-axis direction of the light-emitting region as the X axis, and the fast-axis direction of the light-emitting region as the Y axis.

The light beam emitted from the light-emitting region is collimated in the Y-axis direction by a fast-axis collimating lens 2. For example, a cylindrical lens or a rod lens that has refracting power only in the Y-axis direction is used as the fast-axis collimating lens 2.

The light beam passed through the fast-axis collimating lens 2 spreads in the X-axis direction at a specific angle to the Z axis. A part of the spread light beam is reflected by a mirror 3 acting as a reflector and caused to return to the light-emitting region, thereby causing external resonance. The light beam condensed by external resonance is emitted from the light-emitting region in a direction w which, together with a direction v of the light beam reflected by the mirror 3, is symmetric with respect to the optical axis with the Z axis between the directions v and w.

FIG. 2 is a schematic diagram showing the way the external-resonator laser apparatus of FIG. 1 is mounted on the mount member 4. In FIG. 2, the semiconductor laser 1 has, for example, its back electrode joined to the mount member 4 with solder. An L-shaped terminal 43 is provided to the mount member 4 via an insulator 42. The surface electrode of the semiconductor laser 1 is connected to a terminal 43 with metal fine wires 41. The mount member 4, which serves as a path of current supplied from the terminal 43 to the semiconductor laser 1 via the metal fine wires 41, dissipates the heat generated by the semiconductor laser 1.

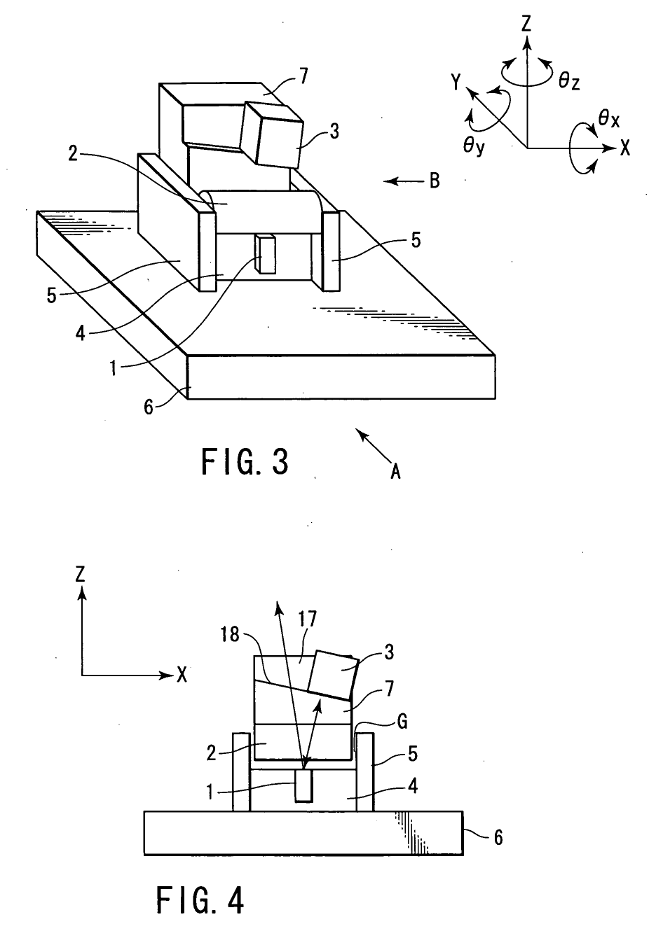

FIG. 3 is a perspective view of the external-resonator laser apparatus of the embodiment. In FIG. 3, the mount member 4 to which the semiconductor laser 1 been joined is fixed to a base plate 6 with screws (not shown) or the like. Side plates 5 are caused to adhere to the mount member 4. Between the side plates 5, the fast-axis collimating lens 2 is inserted.

The fast-axis collimating lens 2 is shaped like a rod or a semicylinder having the major axis in the X-axis direction (or slow axis). The position of the fast-axis collimating lens 2 is adjusted in the X-axis direction, the Y-axis direction, and the Z-axis direction, and further with respect to θx, θy, and θz so that the light beam emitted from the semiconductor laser 1 and passed through the fast-axis collimating lens 2 may become parallel rays of light. The fast-axis collimating lens 2 is secured to the side plates 5 with adhesive applied between the lens 2 and the plates 5 to keep the position-adjusted state. It is desirable to use adhesives with a lower degree of thermal expansion or cure shrinkage. A typical adhesive of this type is ultraviolet-curing adhesive.

In FIG. 3, a mirror 3 is provided above the fast-axis collimating lens 2. The mirror 3 is fixed to a mirror holder 7 at a specific angle beforehand. The mirror holder 7 is inserted between the two side plates 5 and caused to adhere to the plates 5 as is the fast-axis collimating lens 2.

FIG. 4 shows the laser apparatus of FIG. 3 viewed in the direction shown by the arrow A. As shown in FIG. 4, a gap G of, for example, about 100 microns is allowed between the fast-axis collimating lens 2 and mirror holder 7 and each of the two side plates 5. The adhesive that causes the fast-axis collimating lens 2 and mirror holder 7 to adhere to the side plates 5 is applied to the gap G.

At the side of the mirror holder 7 to which the mirror 3 is to be mounted, a cutout part 17 is formed to a specific depth. The cutout part 17 is cut out so as to have such an angle as condenses the light beam emitted from the semiconductor laser 1 and reflected by the mirror 3 to the light-emitting region of the semiconductor laser 1. The mirror 3 is fixed to the mirror holder 7 with adhesive so as to be provided along the edge 18 of the cutout part 17, with the reflecting side of the mirror 3 facing the fast-axis collimating lens 2.

The position of the mirror holder 7 is adjusted in the X-axis direction, the Y-axis direction, and the Z-axis direction, and further with respect to θx, θy, and θz so that the light beam emitted from the semiconductor laser 1 and reflected by the mirror 3 may be condensed to the light-emitting region of the semiconductor laser 1. Then, the mirror holder 7 is secured to the side plates 5 with adhesive to keep the position-adjusted state.

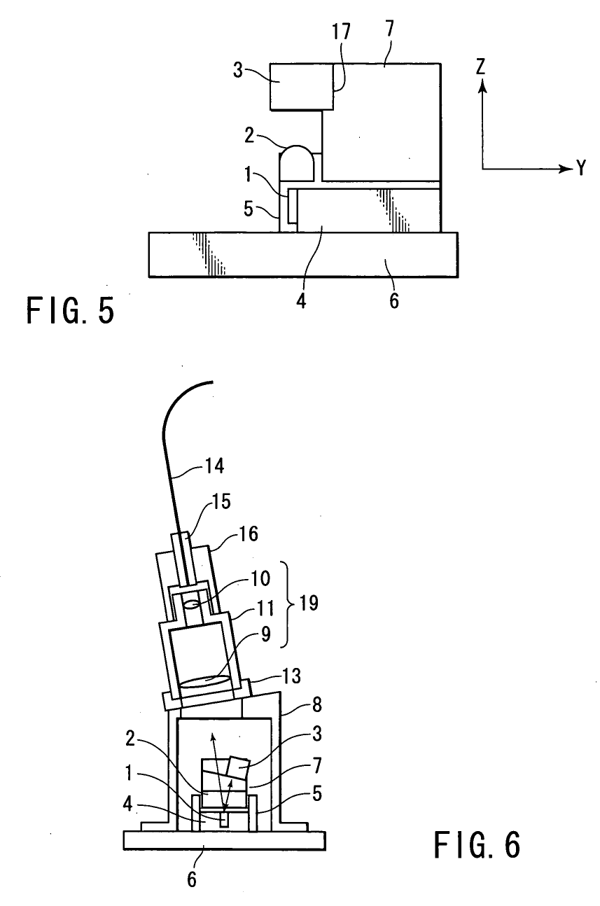

FIG. 5 is a sectional view of the laser apparatus of FIG. 3 taken in the direction shown by the arrow B. In FIG. 5, the mirror 3 is fixed to the cutout part 17 of the mirror holder 7 in such a manner that it cuts into the cutout part 17.

In FIGS. 4 and 5, the light beam emitted from the semiconductor laser 1 passes through the fast-axis collimating lens 2 and is reflected by the mirror 3, which returns the light beam to the light-emitting region of the semiconductor laser 1. As a result, external resonance takes place. Then, as shown in FIG. 4, the light beam produced by external resonance is emitted from the semiconductor laser 1 in a direction which, together with the direction of the light beam reflected by the mirror 3, is symmetric with respect to the Z axis, centering on the light-emitting region.

In the above configuration, the mount member 4 on which the semiconductor laser 1 is mounted, fast-axis collimating lens 2, and mirror 3 are bonded with adhesive in such a manner that they are integral with one another. This makes it unnecessary to provide a mechanism for adjusting the position of each of the semiconductor laser 1, mount member 4, fast-axis collimating lens 2, and mirror 3 separately after the manufacture of the laser apparatus. Consequently, the cost reduction of the laser apparatus can be enhanced, because there is no need to provide a high-cost regulating mechanism.

Furthermore, in the above configuration, the mirror holder 7 and fast-axis collimating lens 2 are fixed to the mount member 4 via the side plates 5 with adhesive in the slow-axis direction of the semiconductor laser 1. As a result, pull strength caused by the cure shrinkage or thermal expansion of adhesive acts only on the X-axis direction (slow-axis direction). Accordingly, a shift in the position in the Y-axis direction and that in the Z-axis direction can be minimized.

In addition, since the fast-axis collimating lens 2 is shaped like a rod extending in the X-axis direction, even if a shift in the position occurs in the X-axis direction, the optical characteristic of the fast-axis collimating lens 2 does not change. Moreover, even if the mirror 3 shifts in the X-axis direction, the distance between the semiconductor laser 1 and the mirror 3 only changes slightly, with the result that a change in the amount of light returning to the light-emitting region is small. As described above, even if a shift in the position has actually occurred in the direction (X-axis direction) in which a shift in the position will possibly take place, this has almost no effect on the optical characteristic related to the external resonance system. Consequently, it is possible to maintain the positional relationship between the semiconductor laser 1, fast-axis collimating lens 2, and mirror 3 with high accuracy over a long period and manufacture an external-resonator semiconductor laser whose performance is stable against variation with time.

FIG. 6 is a sectional view showing the configuration of a laser system using the laser apparatus in FIGS. 3 to 5. In FIG. 6, the same parts as those in FIGS. 3 to 5 are indicated by the same reference numerals. Only the parts of FIG. 6 differing from those of FIGS. 3 to 5 will be explained. FIG. 6 shows a laser apparatus viewed from in the same direction as in FIG. 4.

In FIG. 6, the laser apparatus is covered with a bracket 8 fixed to a base plate 6. The top of the bracket 8 is formed so as to make a slope perpendicular to the emission optical axis of a semiconductor laser 1. A slow-axis collimating lens 9, a condenser lens 10, and a body tube 11, which are assembled with a specific accuracy beforehand, constitute a lens unit 19. The lens unit 19 is caused beforehand to adhere to a ringed lens holder 13 made of transparent material, such as transparent glass or plastic.

The position of the lens unit 19 is adjusted in the X-axis direction, the Y-axis direction, and the Z-axis direction, and further with respect to θx, θy, and θz so that its optical axis may coincide with the optical axis of the light beam emitted from the semiconductor laser 1 to the outside world. The lens unit 19, whose position has been adjusted, is secured to the slope of the top of the bracket 8 with adhesive.

Optical fiber 14 to which the output light beam of the semiconductor laser 1 is directed is inserted into a ferrule 15 beforehand. The end of the optical fiber 14 facing the semiconductor laser 1 is ground, thereby forming an antireflection film at the end. The ferrule 15 is caused beforehand to adhere to a tube-like ferrule holder 16 made of transparent material, such as transparent glass or plastic. With the position of the ferrule holder 16 being adjusted so that the core of the optical fiber 14 may coincide with the position of the focal point of the condenser lens 10, the ferrule holder 16 is fixed to the body tube 11 of the lens unit 19.

In the above configuration, the light beam outputted from the semiconductor laser 1 is made parallel with the fast-axis direction by the fast-axis collimating lens 2. Next, the light beam is made parallel with the slow-axis direction by the slow-axis collimating lens 9. The light beam is then condensed by the condenser lens 10, which then causes the condensed beam to enter the core of the optical fiber 14.

In the configuration, the slow-axis collimating lens 9 and condenser lens 10 are fixed to the body tube 11 with adhesive beforehand. The optical fiber 14 is secured to the ferrule 15 beforehand. The slow-axis collimating lens 9, condenser lens 10, and optical fiber 14 are positioned so as to stand in a straight line in a direction which, together with the direction of the light reflected from the mirror 3, is symmetric with respect to the central axis of the semiconductor laser 1, that is, in the direction of the optical axis of the light beam outputted from the semiconductor laser 1.

Specifically, the position adjusting work is needed only once when the apparatus is produced. Therefore, a complicated adjusting process is unnecessary after the apparatus is produced and therefore neither an expensive adjusting mechanism nor optical-axis replacement parts are needed. As a result, the laser system can be realized at low cost. In addition, since the individual optical parts, including the slow-axis collimating lens 9, condenser lens 10, and optical fiber 14, are assuredly secured, the accuracy of the laser system can be maintained over a long period.

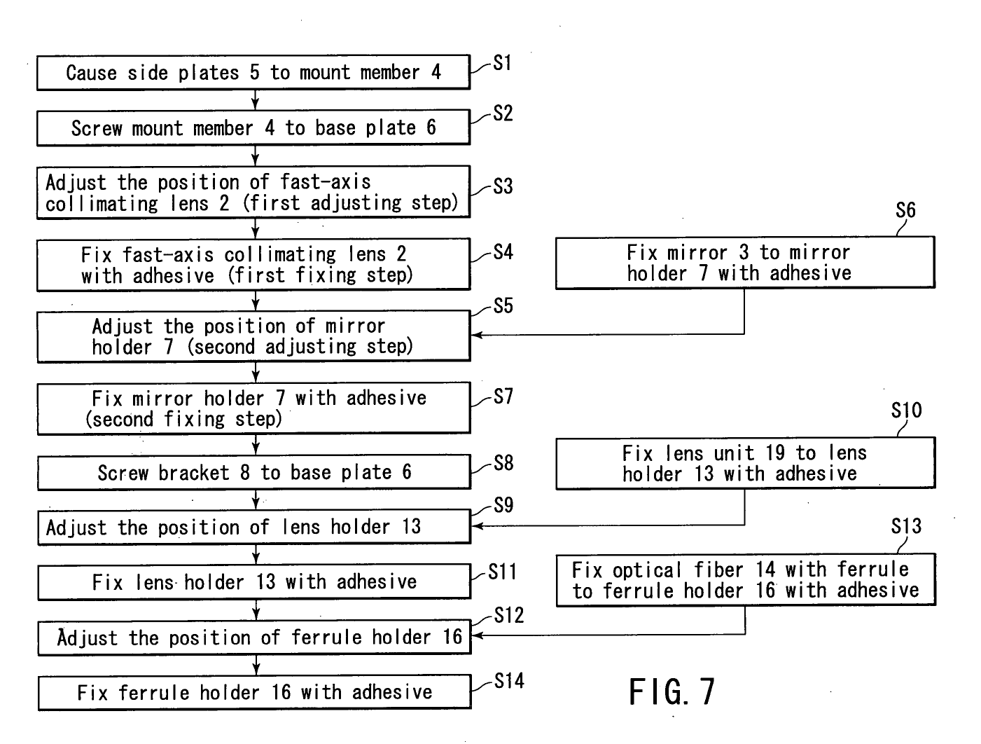

FIG. 7 is a flowchart showing a method of manufacturing the laser apparatus of FIG. 3 and the laser system of FIG. 6. As shown in FIG. 7, the side plate 5 is caused to adhere to either side of the mount member 4 (step S1). Next, the mount member 4 is screwed to the base plate 6 (step S2). Then, the fast-axis collimating lens 2 is supported by an existing adjusting mechanism having the function of making adjustments in the X-axis direction, Y-axis direction, and Z-axis direction, and further with respect to θx, θy, and θz. Then, with the semiconductor laser 1 emitting light, the position and posture of the fast-axis collimating lens 2 are adjusted so that the light beam may become parallel rays of light, while the beam profile of the light beam passed through the fast-axis collimating lens 2 is being observed (step S3).

After this step, the fast-axis collimating lens 2 is caused to adhere to the side plates 5 (step S4). On the other hand, the member which causes the mirror 3 to adhere to the edge 18 of the cutout part 17 of the mirror holder 7 is prepared in advance (step S6). Then, the mirror holder 7 is supported by an existing mechanism having the function of making adjustments in the X-axis direction, Y-axis direction, and Z-axis direction, and further with respect to θx, θy, and θz. Then, with the semiconductor laser 1 emitting light, while the beam profile and optical output of an external resonator are being observed, the position and posture of the mirror holder 7 are adjusted so that the beam spread angle may fit in a specific range and the output strength of the light beam may be maximized (step S5).

After this step, the mirror holder 7 is fixed to the side plates 5 with adhesive (step S7). Next, the bracket 8 is screwed to the base plate 6 (step S8). On the other hand, the lens unit 19 is secured to the lens holder 13 with adhesive beforehand (step S10). Then, the lens unit 19 caused to adhere to the lens holder 13 is supported by an existing mechanism having the function of making adjustments in the X-axis direction, Y-axis direction, and Z-axis direction, and further with respect to θx, θy, and θz. Then, the position and posture of the lens holder 13 are adjusted so that the optical axis of the lens unit 19 may coincide with the optical axis of the light beam emitted from the external resonator (step S9). After this step, the lens holder 13 is fixed to the bracket 8 with adhesive (step S11).

On the other hand, the optical fiber 14 with a ferrule is secured to the ferrule holder 16 with adhesive beforehand (step S13). Then, the ferrule holder 16 is supported by an existing mechanism having the function of making adjustments in the X-axis direction, Y-axis direction, and Z-axis direction, and further with respect to θx, θy, and θz. Then, with the semiconductor laser 1 emitting light, the position and posture of the ferrule holder 16 are adjusted so that the strength of the light beam entering the optical fiber 14 may be maximized (step S12). Finally, the ferrule holder 16 whose position has been adjusted is fixed to the lens unit 19 with adhesive (step S14).

With such a manufacturing method, the positioning adjustment of the fast-axis collimating lens 2 with respect to the semiconductor laser 1 and the positioning adjustment of the mirror 3 with respect to the semiconductor laser 1 can be made separately.

In the prior art, the only one approach was to place the fast-axis collimating lens 2 and mirror 3 on the adjusting stage, move the lens 2 and mirror 3 alternately with respect to the semiconductor laser 1, and find the optimum positional relationship by trial-and-error. Therefore, the positioning control required complicated procedures and a longer time.

In contrast, with the embodiment, after the position of the fast-axis collimating lens 2 is adjusted with respect to the semiconductor laser 1 (step S3), both of them are fixed (step S4). Then, in this state, after the position of the mirror 3 is adjusted with respect to the semiconductor 1 (step S5), both of them are fixed (step S7). As described above, since the steps needed to adjust the positions can be carried out separately, the procedure for the position adjusting work can be simplified. Accordingly, it is possible to realize a manufacturing method which is capable of shortening the time required to assemble the external-resonator laser apparatus and increasing the assembly accuracy and which is suited to mass-produce the external resonator laser apparatus industrially.

In summary, with the embodiment, the cutout part 17 corresponding to the mounting angle of the mirror 3 is formed in the mirror holder 7. The mirror 3 is secured to the mirror holder 7 along the edge 18 of the cutout part 17. The semiconductor laser 1 is fixed to the mount member 4. Then, the semiconductor laser 1 is secured in place in such a manner that the two side plates 5 provided in the slow-axis direction (X-axis direction) of the semiconductor laser 1 sandwich the semiconductor laser 1 between them in the slow-axis direction. Then, the direction of the axis of the rod-like fast-axis collimating lens 2 is caused to coincide with the slow-axis direction. Then, the fast-axis collimating lens 2, together with the mirror holder 7, is secured to the side plates 5. A gap G is allowed between the fast-axis collimating lens 2 and mirror holder 7 and each of the side plates 5. Then, adhesive is applied to the gap G.

By doing this, even when the cure shrinkage or thermal expansion of adhesive occurs, the direction in which pull strength acts is limited only in the X-axis direction (slow-axis direction), with the result that a room for the fast-axis collimating lens 2 and mirror holder 7 to move is restricted only in the slow-axis direction. This minimizes an adverse effect of variation with time on the optical characteristics, which enables the optical accuracy to be maintained over a long period.

Furthermore, since neither an adjusting mechanism nor an optical axis converting section to adjust the positional relationship between the individual sections and maintain the optical positional relationship is needed, the cost of the laser element and laser apparatus can be reduced.

In addition, since the positioning adjustment of the fast-axis collimating lens 2 with respect to the semiconductor laser 1 and the positioning adjustment of the mirror 3 with respect to the semiconductor laser 1 can be carried out separately, the assembly work requiring high accuracy can be done in a short time.

Therefore, it is possible to provide a low-cost laser apparatus capable of being assembled with high accuracy in a short time and maintaining the accuracy over a long period, and a laser system, and a method of manufacturing the laser apparatus.

The present invention is not limited to the embodiment. For instance, while in the embodiment, a single-stripe multimode oscillation semiconductor laser 1 has been used, a so-called multi-stripe multimode oscillation semiconductor laser may be used instead. The light-emitting region of a semiconductor laser of this type is composed of a plurality of active layers.

While in the embodiment, the side plates 5 have been caused to adhere to the mount member 4, they may be formed integrally. By doing this, the step of causing the side plates 5 to adhere to the mount member 4 (step S1) can be eliminated, which is helpful in simplifying the procedures and reducing the cost.

Similarly, while in the embodiment, the mirror 3 has been caused to adhere to the mirror holder 7, both of them may be formed integrally. By doing this, the step of causing the mirror 3 to adhere to the mirror holder 7 (step S7) can be eliminated.

Furthermore, while in the embodiment, adhesive has been used to fix the parts, welding may be used instead. For instance, after the mount member 4 and side plate 5 are formed integrally with a metal member and the position and posture of a metallic mirror holder 7 are adjusted, both of them may be welded by laser. In addition, the lens holder 13 may be eliminated and the bracket 8 and lens unit 19 may be welded directly by laser. Moreover, the ferrule holder 16 may be made of metal and the metal holder 16 may be welded to the lens unit 19 by laser.

Moreover, while in the embodiment, the light beam outputted from the external-resonator laser apparatus has been caused to enter the optical fiber 14, the present invention is not limited to this. For instance, the condenser lens 10 and optical fiber 14 may be eliminated and the light beam may be emitted as it is and used as a processing laser light source. In addition, this invention may be practiced or embodied in still other ways without departing from the spirit or essential character thereof.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A laser apparatus comprising:
a semiconductor laser element which emits a light beam with a spread in a slow-axis direction and a fast-axis direction;
a fast-axis collimating lens controls the spread in the fast-axis direction of the light beam emitted from the semiconductor laser element;
a reflector which returns the light beam emitted in the slow-axis direction in a specific angle range to the semiconductor laser element;
a reflector supporting member which supports the reflector; and
a side support member which supports the fast-axis collimating lens and the reflector supporting member in the slow-axis direction with respect to the semiconductor laser element.

2. The laser apparatus according to claim 1, further comprising:
a mount member on which the semiconductor laser element is mounted and which, together with the fast-axis collimating lens and the reflector supporting member, is integrally formed.

3. The laser apparatus according to claim 2, wherein the fast-axis collimating lens and the reflector supporting member are fixed to the mount member with adhesive.

4. The laser apparatus according to claim 2, wherein the fast-axis collimating lens and the reflector supporting member are welded to the mount member.

5. A laser system comprising:
a laser apparatus;
a slow-axis collimating lens which controls a spread in a slow-axis direction of a light beam emitted from the laser apparatus;
a condenser lens which condenses a light beam passed through the slow-axis collimating lens; and
optical fiber to which the light beam passed through the condenser lens is directed, wherein
the laser apparatus includes
a semiconductor laser element which emits a light beam with a spread in a slow-axis direction and a fast-axis direction,
a fast-axis collimating lens which controls the spread in the fast-axis direction of the light beam emitted from the semiconductor laser element,
a reflector which returns the light beam emitted in the slow-axis direction in a specific angle range to the semiconductor laser element,
a reflector supporting member which supports the reflector, and
a side support member which supports the fast-axis collimating lens and the reflector supporting member in the slow-axis direction with respect to the semiconductor laser element, and
the optical axis of the slow-axis collimating lens, the optical axis of the condenser lens, and the optical axis of the optical fiber are fixed in such a manner that they coincide with a direction which, together with the direction of the light beam reflected from the reflector, is symmetric with respect to the central axis of the semiconductor laser element.

6. The laser system according to claim 5, further comprising:
a mount member on which the semiconductor laser element is to be mounted and which, together with the fast-axis collimating lens and the reflector supporting member, is integrally formed.

7. The laser system according to claim 6, wherein the fast-axis collimating lens and the reflector supporting member are fixed to the mount member with adhesive.

8. The laser system according to claim 6, wherein the fast-axis collimating lens and the reflector supporting member are welded to the mount member.

9. A laser apparatus manufacturing method comprising:
a first adjusting step of adjusting the position of a fast-axis collimating lens which controls a spread in a fast-axis direction of a light beam emitted from a semiconductor laser element emitting a light beam with a spread in the slow-axis direction and the fast-axis direction;
a first fixing step of fixing the fast-axis collimating lens whose position has been adjusted in the first adjusting step to a side support member supporting in the slow-axis direction with respect to the semiconductor laser element;
a mounting step of mounting a reflector with a reflecting face on a reflector supporting member supporting the reflector;
a second adjusting step of adjusting the position of the reflector supporting member with respect to the semiconductor laser element so that a light beam emitted from the semiconductor laser element in the slow-axis direction in a specific angel range may be returned to the semiconductor laser element; and
a second fixing step of fixing the reflector supporting member whose position has been adjusted in the second adjusting step to the side support member.
